(19) United States
(12) Patent Application Publication
(10) Pub. No.: US 2026/0121019 A1
(43) Pub. Date: Apr. 30, 2026

(54) ANODE FOR LITHIUM SECONDARY BATTERY AND LITHIUM SECONDARY BATTERY INCLUDING THE SAMESAME

(71) Applicant: SK On Co., Ltd., Seoul (KR)

(72) Inventors: Ha Jin LEE, Daejeon (KR); Chan Young JEON, Daejeon (KR); Kyung Hoon KIM, Daejeon (KR)

(21) Appl. No.: 19/321,299

(22) Filed: Sep. 8, 2025

(30) Foreign Application Priority Data
Oct. 29, 2024 (KR) 10-2024-0149501

(51) Int. Cl. H01M 4/133; H01M 4/02; H01M 4/36; H01M 4/587; H01M 10/0525

(52) U.S. Cl. CPC H01M 4/133; H01M 4/366; H01M 4/587; H01M 10/0525; H01M 2004/021; H01M 2004/027

(57) ABSTRACT

An anode for a lithium secondary battery includes an anode current collector and an anode mixture layer on at least one surface of the anode current collector. The anode mixture layer includes a carbon-based active material, and the anode for a lithium secondary battery has an orientation index increase ratio (R_{OI}) of 120% to 400% according to Formula 1, R_{OI}=100×(OI₂−OI₁)/(OI₁), where OI₁ is I₀₀₄/I₁₁₀ according to X-ray diffraction (XRD) analysis of the carbon-based active material, and OI₂ is I₀₀₄/I₁₁₀ according to X-ray diffraction (XRD) analysis of the anode mixture layer. Therefore, an anode for a lithium secondary battery having excellent energy density may be provided.

### CROSS-REFERENCE TO RELATED APPLICATION(S)

This patent document claims the priority and benefits of Korean Patent Application No. 10-2024-0149501 filed on Oct. 29, 2024, the disclosure of which is incorporated herein by reference in its entirety.

### TECHNICAL FIELD

The disclosure and implementations disclosed in this patent document generally relate to an anode for a lithium secondary battery and a lithium secondary battery including the same.

### BACKGROUND

Recently, research into electric vehicles (EVs) that may replace fossil fuel vehicles such as gasoline and diesel powered vehicles, which are one of the main causes of air pollution, is being conducted extensively. Lithium secondary batteries with high discharge voltage and output stability are mainly used as the power source for such electric vehicles (EVs). Accordingly, the need for an anode for a lithium secondary battery with excellent performance is increasing.

### SUMMARY

The present disclosure can be implemented in some embodiments to improve the energy density of an anode for a lithium secondary battery.

An aspect of the present disclosure is to suppress the occurrence of a spring back phenomenon in an anode for a lithium secondary battery.

An aspect of the present disclosure is to provide an anode for a lithium secondary battery having excellent lifespan characteristics.

An aspect of the present disclosure is to reduce costs in manufacturing an anode for a lithium secondary battery.

In some embodiments of the present disclosure, an anode for a lithium secondary battery includes an anode current collector and an anode mixture layer on at least one surface of the anode current collector. The anode mixture layer includes a carbon-based active material, and the anode for a lithium secondary battery has an orientation index increase ratio (R_{OI}) of 120% to 400% according to the following Formula 1.

$${R}_{O I} = 100 \times ( O {I}_{2} - O {I}_{1} ) / ( {OI}_{1} ) \qquad [ Formula 1 ]$$

In Formula 1 above, R_{OI} is an orientation index (OI) increase rate (%), OI₁ is a ratio (I₀₀₄/I₁₁₀) of a peak intensity (I₀₀₄) of the (004) plane to a peak intensity (I₁₁₀) of the (110) plane according to X-ray diffraction (XRD) analysis of the carbon-based active material, and OI₂ is a ratio (I₀₀₄/I₁₁₀) of a peak intensity (I₀₀₄) of the (004) plane to a peak intensity (I₁₁₀) of the (110) plane according to X-ray diffraction (XRD) analysis of the anode mixture layer.

In some implements, the anode for a lithium secondary battery may have an orientation index increase ratio (R_{OI}) of 190% to 270%.

In some implements, the anode for a lithium secondary battery may have an OI₂ value of 7 to 15.

In some implements, the carbon-based active material may include artificial graphite.

In some implements, the artificial graphite may have a single particle form.

In some implements, the artificial graphite may include a carbon coating layer on a surface thereof.

In some implements, the carbon-based active material may include artificial graphite and natural graphite.

In some implements, a weight of the artificial graphite in the carbon-based active material may be equal to or greater than a weight of the natural graphite.

In some implements, the natural graphite may include a carbon coating layer on a surface thereof.

In some implements, an electrode density of the anode mixture layer may be 1.4 g/cc to 1.7 g/cc.

In some embodiments of the present disclosure, a lithium secondary battery includes the anode for a lithium secondary battery according to any one of the above-described implements.

### BRIEF DESCRIPTION OF DRAWINGS

Certain aspects, features, and advantages of the present disclosure are illustrated by the following detailed description with reference to the accompanying drawings.

FIG. 1 is a drawing conceptually illustrating a basal plane corresponding to the basal plane and an edge plane formed by the edges of the respective basal planes in a carbon-based active material having a parallel laminated structure.

### DETAILED DESCRIPTION

Features of the present disclosure disclosed in this patent document are described by example embodiments with reference to the accompanying drawings.

In this specification, the ‘orientation’ of the mixture layer and the active material means a characteristic represented by the ‘Orientation Index (OI)’ value (I₀₀₄/I₁₁₀) determined by the peak intensity ratio between the peak intensity (I₀₀₄) of the (004) plane and the peak intensity (I₁₁₀) of the (110) plane according to XRD measurement. For example, a relatively smaller OI value of the mixture layer and the active material indicates a low-orientation mixture layer and active material with small orientation, and a relatively larger OI value indicates a high-orientation mixture layer and active material with large orientation.

To provide a high-performance lithium secondary battery, an anode for a lithium secondary battery according to an embodiment may include artificial graphite manufactured with coke, as an anode active material. The artificial graphite has many passages through which lithium ions may pass, and thus may improve the high-power performance and rapid charging performance of the lithium secondary battery.

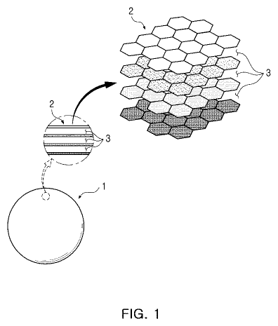

In detail, the orientation of the carbon-based active material such as the artificial graphite will be described in detail below with reference to FIG. 1. FIG. 1 is a drawing conceptually illustrating a basal plane corresponding to the basal plane and an edge plane formed by gathering the edges of the respective basal planes.

The carbon-based active material 1 such as the artificial graphite generally includes carbon layers in which hexagonal rings consisting of six carbons are connected in a plane, and the carbon layers are laminated in parallel to each other (see FIG. 1). In the carbon-based active material 1, the basal plane 2 corresponds to the basal plane in the carbon layer having a parallel-laminated structure, and the edge plane 3 means a plane (Edge Plane) formed by gathering the edges of the respective basal planes.

During the charging and discharging process of a lithium secondary battery, the intercalation and deintercalation phenomena in which lithium ions are stored and released in the carbon-based active material 1 are mainly performed through the edge plane 3. Therefore, as the number of these edge planes 3 increases, the intercalation and deintercalation of lithium ions during the charging process become easier, and the rapid charging characteristics may also become more excellent.

In this regard, the orientation index (OI) value determined by X-ray diffraction (XRD) analysis of the carbon-based active material 1 refers to a ratio of the peak intensity of the (004) plane compared to the peak intensity of the (110) plane, and the smaller the OI value of the carbon-based active material 1, the more the number of edge planes 3 may be relatively greater compared to the basal plane 2. This is determined that because the smaller the orientation index (OI) value, the more disordered the crystal arrangement, and the more edge planes 3 through which lithium ions may enter and exit. Therefore, when the carbon-based active material included in the anode is a low orientation carbon-based active material with a small orientation index (OI) value, the lithium ions may enter and exit easily through many edge planes 3, and thus, the output performance and rapid charging performance may be excellent.

However, the lower the ‘orientation,’ the higher the hardness of the carbon-based active material, which may make it difficult to roll the carbon-based active material with low orientation at high density. Accordingly, when the anode includes the carbon-based active material with low orientation, it may be difficult to secure the energy density of the anode because it is difficult to increase the rolling density of the anode. In addition, the carbon-based active material with low orientation may cause additional side reactions or reduce the life performance of the battery due to particle damage during the rolling process.

In this regard, the artificial graphite is a low-orientation active material with low ‘orientation,’ and it may not be easy to roll an anode including the artificial graphite at high density. In detail, in the anode including the artificial graphite, the so-called ‘spring back’ phenomenon, in which the active materials included in the anode rise again after rolling and the anode expands, may be aggravated. This ‘spring back’ phenomenon may make it difficult to secure the energy density of the electrode when designing a lithium secondary battery because the actual electrode thickness is different from a target thickness.

In addition, the artificial graphite may be subjected to a large stress during the rolling process of the anode including the same, and the particles may be damaged. Accordingly, the performance of the lithium secondary battery including the anode may be deteriorated.

According to an embodiment, an anode for a lithium secondary battery is provided, which may alleviate the above-described problems. Hereinafter, embodiments of the present disclosure will be described in detail.

### Anode for Lithium Secondary Battery

According to an embodiment, an anode for a lithium secondary battery includes an anode current collector and an anode mixture layer on at least one surface of the anode current collector, and the anode mixture layer includes a carbon-based active material, and the anode for a lithium secondary battery has an orientation index increase ratio (R_{OI}) of 120% to 400% according to the following Formula 1.

$${R}_{O I} = 100 \times ( O {I}_{2} - O {I}_{1} ) / ( {OI}_{1} ) \qquad [ Formula 1 ]$$

In the above Formula 1, R_{OI} is the orientation index (OI) increase rate (%), OI₁ is the ratio (I₀₀₄/I₁₁₀) of the peak intensity (I₀₀₄) of the (004) plane to the peak intensity (I₁₁₀) of the (110) plane according to X-ray diffraction (XRD) analysis of the carbon-based active material, and OI₂ is the ratio (I₀₀₄/I₁₁₀) of the peak intensity (I₀₀₄) of the (004) plane to the peak intensity (I₁₁₀) of the (110) plane according to X-ray diffraction (XRD) analysis of the anode mixture layer.

The components of the anode current collector are not particularly limited. For example, the anode current collector may be a plate or foil formed of at least one of indium (In), copper (Cu), magnesium (Mg), stainless steel, titanium (Ti), iron (Fe), cobalt (Co), nickel (Ni), zinc (Zn), aluminum (Al), germanium (Ge), lithium (Li), and alloys thereof. The thickness of the anode current collector is not particularly limited. For example, the thickness of the anode current collector may be 0.1 μm to 50 μm.

According to the embodiment, during the manufacturing process of the anode including the carbon-based active material, the ‘orientation’ change rate between the carbon-based active material and the anode is controlled within a specific range, thereby improving the performance of the lithium secondary battery. In detail, the anode for a lithium secondary battery may have excellent performance by significantly reducing the stress applied to the carbon-based active material during the manufacturing process and suppressing the occurrence of the ‘spring back’ phenomenon described above. Accordingly, the anode for a lithium secondary battery may have an orientation index increase ratio (R_{OI}) value of 120% to 400%, in detail, 120% to 350%, and in more detail, 120% to 300% according to Formula 1 above.

The orientation index (OI) value may be calculated as a ratio (I₀₀₄/I₁₁₀) between peak intensity (I₀₀₄) shown on the (004) plane and peak intensity (I₁₁₀) shown on the (110) plane during X-ray diffraction (XRD) analysis for a specific target. The peak intensity (I₀₀₄) shown on the (004) plane may be a peak intensity value of the (004) plane that appears at an angle of 2θ=54.7±0.2° during XRD measurement using CuKα rays, and the peak intensity (I₁₁₀) shown on the (110) plane may be a peak intensity value of the (110) plane that appears at an angle of 2θ=77.5±0.2° during XRD measurement using CuKα rays. The peak intensity value may refer to a height value or an integrated area value of a specific peak. In some implementations, the I₀₀₄/I₁₁₀ value may be calculated as a ratio value between the integrated areas of respective peaks.

In some implementations, the anode for a lithium secondary battery may have an orientation index increase ratio (R_{OI}) of 190% to 270%. For example, the orientation index increase ratio (R_{OI}) of the anode for a lithium secondary battery may be 195% or more, 200% or more, 210% or more, 212% or more, 213% or more, or 220% or more, and may be 265% or less, 263% or less, 260% or less, 250% or less, 240% or less, 230% or less, or 220% or less. When the orientation index increase ratio (R_{OI}) of the anode for a lithium secondary battery is within the above-described range, the life performance of the lithium secondary battery may be improved while reducing the electrode expansion rate.

In some implementation examples, the anode for a lithium secondary battery may have an OI₁ value of 0.5 to 3.5 according to the Formula 1. In detail, the orientation index (OI₁) value of the carbon-based active material included in the anode for a lithium secondary battery may be 0.5 to 3.5. For example, the orientation index (OI₁) value of the carbon-based active material may be 1 or more, 2.0 or more, 2.1 or more, 2.4 or more, 2.5 or more, 2.7 or more, 2.8 or more, or 3 or more, and may be 3.5 or less, 3.2 or less, 3 or less, or 2.8 or less. The orientation index (OI₁) value of the carbon-based active material may be a value obtained by measuring the orientation index (OI) of the carbon-based active material collected by washing the anode after disassembling the lithium secondary battery.

In some implementation examples, the anode for a lithium secondary battery may have an OI₂ value of 7 to 15 according to the Formula 1. In detail, the orientation index (OI₂) value of the anode mixture layer of the anode for a lithium secondary battery may be 7 to 15. For example, the orientation index (OI₂) value of the anode mixture layer may be 7.1 or more, 7.2 or more, 9 or more, 9.3 or more, 10 or more, 10.1 or more, or 10.7 or more, and may be 13 or less, 11 or less, 10.8 or less, 10 or less, or 9.2 or less. The orientation index (OI₂) value of the anode mixture layer may be a value obtained by measuring the orientation index (OI) of the anode mixture layer of the anode after disassembling the lithium secondary battery.

In some implementation examples, the average particle size (D50) of the carbon-based active material may be 1 μm to 20 μm. For example, the average particle size (D50) of the carbon-based active material may be 5 μm or more, 8 μm or more, 10 μm or more, or 11 μm or more, and may be 15 μm or less or 12 μm or less.

The carbon-based active material is not particularly limited. For example, the carbon-based active material may be a carbon-based material such as crystalline carbon, amorphous carbon, a carbon composite, or carbon fiber. The crystalline carbon may be, for example, graphite-based carbon such as natural graphite, artificial graphite, graphitized coke, graphitized mesocarbon microbeads (MCMB), or graphitized mesophase pitch-based carbon fibers (MPCF). The amorphous carbon may be, for example, hard carbon, soft carbon, coke, mesocarbon microbead (MCMB), or mesophase pitch-based carbon fiber (MPCF).

In some embodiments, the carbon-based active material may include artificial graphite. The artificial graphite may be manufactured from coke. When the carbon-based active material includes artificial graphite, the ‘orientation’ of the anode mixture layer may be easily controlled, thereby securing cost competitiveness.

In some embodiments, the artificial graphite may have a single particle form. When the anode for a lithium secondary battery includes artificial graphite having a single particle form, the life characteristics and output characteristics of the lithium secondary battery including the same may be further improved.

The single particle may be morphologically distinguished from a secondary particle formed by agglomeration of primary particles. For example, the single particle and the secondary particle may be distinguished based on a cross-sectional image of the particle measured by a scanning electron microscope (SEM).

In some embodiments, the secondary particle may refer to a particle in which a plurality of primary particles are aggregated and are substantially regarded or observed as one particle. For example, the secondary particle may be an aggregate of more than 10, 30 or more, 50 or more, or 100 or more to 1000 or less primary particles. For example, in the case of the secondary particle, the boundary of the primary particles may be observed in the SEM cross-sectional image.

In some implementations, the single particle may refer to a monolith rather than an aggregate. For example, in the case of the single particle, unlike the secondary particle, the boundary of the primary particles may not be observed in the SEM cross-sectional image. Meanwhile, fine particles (for example, particles having a volume of 1/100 or less of the volume of the single particle) may be attached to the surface of the single particle, and the form is not excluded from the concept of the single particle.

In some implementations, the single particles may exist in contact with each other. For example, the single particles may exist in 2 to 10, 2 to 5, or 2 to 3 single particles in contact with each other.

In some implementations, the artificial graphite may include a carbon coating layer on the surface. For example, the artificial graphite may include an amorphous carbon coating layer on the surface. The amorphous carbon coating layer may be formed by mixing the artificial graphite and a carbon precursor and then heat-treating the same. The carbon precursor is not particularly limited. For example, the carbon precursor may be at least one selected from among a polymer resin such as a polyvinyl alcohol resin, a polyacrylonitrile resin, a polyamide resin, or the like; and a pitch such as a coal-based pitch, a petroleum-based pitch, a mesophase pitch, or the like. The heat treatment temperature may be, for example, 1,000° C. to 1,800° C. In this case, the hardness of the artificial graphite may be improved, thereby reducing the electrode expansion ratio of the anode including the same.

In some embodiments, the content of the carbon coating layer may be 1 wt % to 10 wt % based on the total weight of the artificial graphite. For example, the content of the carbon coating layer based on the total weight of the artificial graphite may be 1 wt % or more or 1.5 wt % or more, and may be 5 wt % or less, 3 wt % or less or 1.5 wt % or less. If the content of the carbon coating layer is less than 1 wt %, it may be difficult to obtain the surface coating effect of the artificial graphite. On the other hand, when the content of the carbon coating layer exceeds 10 wt %, the hardness of the artificial graphite becomes excessively high, making it difficult to secure the energy density of the anode including the same.

In some implementation examples, the carbon-based active material may include artificial graphite and natural graphite. A detailed description of the artificial graphite overlaps with the above-described content, so it is omitted. The natural graphite is a carbon-based active material with a relatively high ‘orientation’ compared to the artificial graphite, and may have a lower hardness compared to the artificial graphite. Therefore, the anode including the natural graphite may be easily rolled at a high density and thus may have a high energy density. In addition, when the anode includes natural graphite, the occurrence of the ‘spring back’ phenomenon described above may be alleviated.

In some embodiments, the weight of the artificial graphite in the carbon-based active material may be greater than or equal to the weight of the natural graphite. As described above, natural graphite may contribute to improving the energy density of the anode as a carbon-based active material with high orientation, but may be excessively packed during the rolling process of the anode including the same. Accordingly, in the anode including the natural graphite as the anode active material, the surface pressure stress between the active materials may increase during the operation process of the lithium secondary battery, which may cause the active material to peel off, and the life performance of the lithium secondary battery may be inferior.

Therefore, in the anode for a lithium secondary battery including the carbon-based active material, artificial graphite and natural graphite, when the weight of the artificial graphite is adjusted to be greater than or equal to the weight of the natural graphite, the occurrence of the above-described problem may also be suppressed within a range where the effect due to the addition of natural graphite is not hindered.

In some embodiments, the weight ratio of the artificial graphite and natural graphite in the carbon-based active material may be 51:49 to 99:1. For example, the weight ratio of the artificial graphite and natural graphite in the carbon-based active material may be 55:45 to 95:5, or 60:40 to 80:20.

In some embodiments, the natural graphite may have a sphericity of 0.85 to 0.99. When the natural graphite undergoes a sphericity process and has a sphericity within the above-described range, the energy density of the anode including the same and the output of the lithium secondary battery may be improved. The sphericity may refer to the ratio of the shortest diameter (minor diameter) and the longest diameter (major diameter) among any diameters passing through the center of the particle. For example, the closer the sphericity is to 1, the closer the particle shape is to a sphere. The sphericity may be measured using a particle shape analyzer.

In some embodiments, the natural graphite may include a carbon coating layer on the surface. For example, the natural graphite may include an amorphous carbon coating layer on the surface. The amorphous carbon coating layer may be formed by mixing natural graphite and a carbon precursor and then performing a heat treatment. The carbon precursor is not particularly limited. For example, the carbon precursor may be at least one selected from a polymer resin such as a polyvinyl alcohol resin, a polyacrylonitrile resin, a polyamide resin or the like; and a pitch such as a coal-based pitch, a petroleum-based pitch, a mesophase pitch or the like. The heat treatment temperature may be, for example, 1,000° C. to 1,800° C. In this case, the hardness of the natural graphite may be improved, thereby reducing the electrode expansion rate of the anode including the same.

In some embodiments, the content of the carbon coating layer may be 1 wt % to 10 wt % based on the total weight of the natural graphite. For example, the content of the carbon coating layer may be 1 wt % or more, or 1.5 wt % or more, and may be 5 wt % or less, 3 wt % or less, or 1.5 wt % or less, based on the total weight of the natural graphite. If the content of the carbon coating layer is less than 1 wt %, it may be difficult to obtain a surface coating effect of the natural graphite. On the other hand, if the content of the carbon coating layer exceeds 10 wt %, the hardness of the natural graphite may be excessively high, making it difficult to secure the energy density of the anode including the same.

In some embodiments, the content of the carbon-based active material included in the anode mixture layer may be 70 wt % to 99 wt %. For example, the content of the carbon-based active material included in the anode mixture layer may be 90 wt % to 95 wt %.

In some embodiments, the anode mixture layer may further include an anode active material other than the carbon-based active material. For example, the anode mixture layer may further include at least one selected from the group consisting of lithium metal, lithium alloy, a silicon-containing material, and a tin-containing material as the anode active material.

The element included in the lithium alloy may be, for example, aluminum, zinc, bismuth, cadmium, antimony, silicon, lead, tin, gallium, or indium.

The silicon-containing material is not particularly limited as long as it contains silicon, and may be an active material that may be alloyed with lithium (Li). For example, the silicon-containing material may be at least one selected from the group consisting of silicon (Si), silicon oxide (SiOx; 0<x<2), metal-doped silicon oxide (SiOx; 0<x<2), carbon-coated silicon oxide (SiOx; 0<x<2), silicon-carbon composite (Si—C), and silicon alloy.

In some embodiments, the anode mixture layer may further include a binder. The binder is not particularly limited. For example, the binder may be selected from a rubber-based binder such as styrene-butadiene rubber (SBR), fluorine-based rubber, ethylene propylene rubber, butadiene rubber, isoprene rubber, or silane-based rubber; a cellulose-based binder such as carboxymethyl cellulose (CMC), hydroxypropylmethylcellulose, methylcellulose, or an alkali metal salt thereof; and combinations thereof. The content of the binder included in the anode mixture layer may be, for example, 0.1 wt % to 10 wt %.

In some embodiments, the anode mixture layer may further include a conductive material. The conductive material is not particularly limited. For example, the conductive material may be selected from graphite such as natural graphite or artificial graphite; a carbon-based material such as carbon black, acetylene black, Ketjen black, channel black, furnace black, lamp black, thermal black, carbon fiber, or carbon nanotubes (CNT); metal powders or metal fibers such as copper, nickel, aluminum, or silver; conductive whiskers such as zinc oxide or potassium titanate; conductive metal oxides such as titanium oxide; a conductive polymer such as polyphenylene derivatives; and combinations thereof. The content of the conductive material included in the anode mixture layer may be, for example, 0.1 wt % to 10 wt %.

In some implementations, the electrode density of the anode mixture layer may be 1.4 g/cc to 1.7 g/cc. For example, the electrode density of the anode mixture layer may be 1.5 g/cc or more, or 1.6 g/cc or more, or may be 1.7 g/cc or less. When the electrode density of the anode mixture layer is within the above-described range, an anode for a lithium secondary battery having excellent energy density and life performance may be provided.

### Method of Manufacturing Anode for Lithium Secondary Battery

A method of manufacturing an anode for lithium secondary battery according to an embodiment includes an operation of forming an anode mixture layer on at least one surface of an anode current collector, and the anode mixture layer includes a carbon-based active material. The anode for a lithium secondary battery has an orientation index increase ratio (R_{OI}) of 120% to 400% according to Formula 1. Detailed descriptions of the anode current collector, the anode mixture layer, the carbon-based active material, Formula 1, and the like overlap with the above-described contents, and thus are omitted.

In some embodiments, the anode mixture layer may be formed by applying an anode slurry including the carbon-based active material described above on at least one surface of an anode current collector and then drying the same. The method for applying the anode slurry is not particularly limited. For example, the anode slurry may be applied to the surface of the anode current collector by a method such as bar coating, casting, or spraying. The drying temperature of the anode slurry is not particularly limited. For example, the drying of the anode slurry may be performed at a temperature of 90° C. to 120° C.

In some embodiments, the anode slurry may further include at least one of a conductive agent and a binder. Detailed descriptions of the conductive agent, binder, and the like overlap with the above-described contents, and thus are omitted.

In some embodiments, the anode slurry may further include a solvent. The solvent is not particularly limited. For example, dimethyl sulfoxide (DMSO), isopropyl alcohol, N-methylpyrrolidone (NMP), acetone, water, or the like may be used as the solvent. The amount of the solvent used is not particularly limited as long as it dissolves or disperses the components in consideration of the coating thickness of the slurry, the manufacturing yield, or the like, and has a viscosity that may exhibit excellent thickness uniformity when applied on the current collector.

In some embodiments, the method of manufacturing an anode for lithium secondary battery may further include an operation of rolling the anode current collector and the anode mixture layer formed on at least one surface of the anode current collector. For example, the rolling may be performed so that the electrode density of the anode mixture layer becomes 1.4 g/cc to 1.7 g/cc. A detailed description of the electrode density is omitted because it overlaps with the above-described content.

### Lithium Secondary Battery

A lithium secondary battery according to an embodiment includes an anode for a lithium secondary battery according to any one of the above-described embodiments. For example, the lithium secondary battery may include a unit cell including the anode for a lithium secondary battery, a cathode, and a separator. The separator may be disposed between the cathode and the anode.

The cathode may include a cathode current collector and a cathode mixture layer on at least one surface of the cathode current collector.

The components of the cathode current collector are not particularly limited. For example, the cathode current collector may be a plate or foil formed of at least one of indium (In), copper (Cu), magnesium (Mg), stainless steel, titanium (Ti), iron (Fe), cobalt (Co), nickel (Ni), zinc (Zn), aluminum (Al), germanium (Ge), lithium (Li), and alloys thereof. The thickness of the cathode current collector is not particularly limited. For example, the thickness of the cathode current collector may be 0.1 μm to 50 μm.

The cathode mixture layer may include a cathode active material. The cathode active material is not particularly limited, and may include a compound capable of reversibly intercalating and deintercalating lithium ions. For example, the cathode active material may include a lithium-nickel metal oxide. The lithium-nickel metal oxide may further include at least one of cobalt (Co), manganese (Mn), and aluminum (Al).

In some embodiments, the cathode active material or the lithium-nickel metal oxide may include a layered structure or a crystal structure represented by the following Chemical Formula 1.

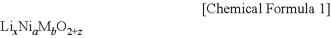

In the Chemical Formula 1, 0.9≤x≤1.2, 0.6≤a≤0.99, 0.01≤b≤0.4, and −0.5≤z≤0.1 may be satisfied. As described above, M may include Co, Mn, and/or Al.

The chemical structure represented by the Chemical Formula 1 represents a bonding relationship included in the layered structure or crystal structure of the cathode active material and does not exclude other additional elements. For example, M includes Co and/or Mn, and Co and/or Mn may serve as a main active element of the cathode active material together with Ni. The above Chemical Formula 1 is provided to express the bonding relationship of the main active element and should be understood as the formula encompassing the introduction and substitution of additional elements.

In some implementations, auxiliary elements may be further included in addition to the main active element to enhance the chemical stability of the cathode active material or the layered structure/crystal structure. The auxiliary elements may be incorporated together in the layered structure/crystal structure to form bonds, and in this case, it should be understood that the auxiliary elements are also included within the chemical structure range represented by the Chemical Formula 1.

The auxiliary element may include at least one of Na, Mg, Ca, Y, Ti, Hf, V, Nb, Ta, Cr, Mo, W, Fe, Cu, Ag, Zn, B, Al, Ga, C, Si, Sn, Sr, Ba, Ra, P, or Zr, for example. The auxiliary element may also act as an auxiliary active element that contributes to the capacity/output activity of the cathode active material, such as Al, together with Co or Mn.

For example, the cathode active material or the lithium-nickel metal oxide may include a layered structure or a crystal structure represented by the following Chemical Formula 1-1.

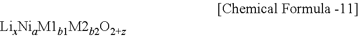

In the Chemical Formula 1-1, M1 may include Co, Mn, and/or Al. M2 may include the auxiliary element described above. In the Chemical Formula 1-1, 0.9≤x≤1.2, 0.6≤a≤0.99, 0.01≤b1+b2≤0.4, and −0.5≤z≤0.1 may be satisfied.

The cathode active material may further include a coating element or a doping element. For example, elements substantially identical to or similar to the auxiliary elements described above may be used as the coating element or the doping element. For example, the elements described above may be used alone or in combination of two or more as the coating element or the doping element.

The coating element or doping element may be present on the surface of the lithium-nickel metal oxide particle, or may penetrate through the surface of the lithium-nickel metal oxide particle and be included in the bonding structure represented by the Chemical Formula 1 or the Chemical Formula 1-1 above.

The cathode active material may include a nickel-cobalt-manganese (NCM)-based lithium oxide. In this case, an NCM-based lithium oxide having an increased nickel content may be used.

The content of Ni in the NCM-based lithium oxide (for example, the mole fraction of nickel in the total moles of nickel, cobalt, and manganese) may be 0.6 or more, 0.7 or more, or 0.8 or more. In some embodiments, the Ni content may be 0.8 to 0.95, 0.82 to 0.95, 0.83 to 0.95, 0.84 to 0.95, 0.85 to 0.95, or 0.88 to 0.95.

In some embodiments, the cathode active material may include a lithium cobalt oxide-based active material, a lithium manganese oxide-based active material, a lithium nickel oxide-based active material, or a lithium iron phosphate (LFP)-based active material (for example, LiFePO₄).

In some embodiments, the cathode active material may include a Mn-rich active material, a Li rich layered oxide (LLO)/over lithiated oxide (OLO)-based active material, or a Co-less active material having a chemical structure or crystal structure represented by Chemical Formula 2.

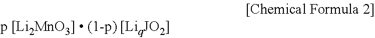

In Chemical Formula 2, 0<p<1, 0.9≤q≤1.2, and J may include at least one element among Mn, Ni, Co, Fe, Cr, V, Cu, Zn, Ti, Al, Mg, and B.

The cathode mixture layer may further include a binder. The binder is not particularly limited. For example, the binder may include one, or two or more of styrene butadiene rubber (SBR), polytetrafluoroethylene, polyvinylidenefluoride, vinylidene fluoride/hexafluoropropylene copolymer, polyacrylonitrile, polymethyl methacrylate, and the like.

The cathode mixture layer may further include a conductive material. The conductive material is not particularly limited. For example, the conductive material may include one, or two or more of graphite such as natural graphite or artificial graphite; a carbon-based material such as carbon black, acetylene black, Ketjen black, channel black, furnace black, lamp black, thermal black, carbon fiber, and carbon nanotube (CNT); metal powder or metal fiber such as copper, nickel, aluminum, or silver; conductive whiskers such as zinc oxide and potassium titanate; conductive metal oxides such as titanium oxide; or a conductive polymer such as polyphenylene derivatives.

The separator is not particularly limited. For example, the separator may include a porous polymer film manufactured from a polyolefin polymer such as an ethylene homopolymer, a propylene homopolymer, an ethylene/butene copolymer, an ethylene/hexene copolymer, or an ethylene/methacrylate copolymer. In addition, the separator may include a nonwoven fabric formed of high-melting point glass fiber, polyethylene terephthalate fiber, or the like.

In some embodiments, the lithium secondary battery may be manufactured by housing the unit cell described above in a pouch, which is a battery case, and then injecting an electrolyte.

The electrolyte may include an organic solvent and a lithium salt. The organic solvent acts as a medium through which ions involved in the electrochemical reaction of the battery may move, and for example, carbonate-based, ester-based, ether-based, ketone-based, alcohol-based, or aprotic solvent may be used alone or in combination of two or more, and the mixing ratio in the case of using two or more in combination may be appropriately adjusted according to the required battery performance.

The lithium salt is dissolved in an organic solvent and acts as a source of lithium ions in the battery, and is a substance that enables the basic operation of a lithium secondary battery and promotes the movement of lithium ions between the cathode and the anode. As the lithium salt, a known material may be used at a concentration appropriate for the use. The electrolyte may further include a known solvent to improve charge/discharge characteristics, flame retardancy characteristics, and the like, as needed, and may include a known additive.

In some implementations, the unit cell may include a solid electrolyte instead of a separator between the cathode and the anode. The solid electrolyte is not particularly limited, and may be, for example, an oxide-based solid electrolyte, a sulfide-based solid electrolyte, or a polymer-based solid electrolyte.

### EXAMPLES AND COMPARATIVE EXAMPLES

### 1) Preparation of Anode Active Material

A carbon-based active material was prepared as an anode active material of the examples and comparative examples, as illustrated in Table 1 below. In detail, seven types of artificial graphite (A to E, A′ and A″) having different average particle sizes (D50) and/or particle shapes were prepared. Thereamong, A′ is a carbon-based active material in which an amorphous carbon coating layer of 1.0 wt % based on the total weight of the artificial graphite is formed on the surface of one type of artificial graphite (A), and A″ is a carbon-based active material in which an amorphous carbon coating layer of 1.5 wt % based on the total weight of the artificial graphite is formed on the surface of one type of artificial graphite (A). In addition, natural graphite (G) was prepared as natural graphite that was spheroidized through a spheroidization process and had an amorphous carbon coating layer of 5 wt % on the surface.

The carbon-based active material prepared by mixing the carbon-based active materials in combinations as illustrated in Table 2 below was used as the anode active material of the examples and comparative examples. Afterwards, the value (OI₁) obtained by measuring the orientation index (OI) for the carbon-based active materials of the above examples and comparative examples is illustrated in Table 2 below.

In detail, the orientation index (OI) was calculated by respectively measuring the peak intensity (I₀₀₄) of the (004) plane and the peak intensity (I₁₁₀) of the (110) plane according to X-ray diffraction (XRD) analysis, and then calculating the ratio (I₀₀₄/I₁₁₀) of the peak intensity (I₀₀₄) of the (004) plane to the peak intensity (I₁₁₀) of the (110) plane. At this time, the I₀₀₄/I₁₁₀ value was calculated as the ratio value between the integrated areas of respective peaks. In addition, the peak intensity value was measured using an XRD device (Empyrean by PANalytical) with CuKα rays as the target line. In addition, the measurement conditions were 2θ=10° to 80°, scan speed (°/S)=3, and step size was 0.025°/step.

### 2) Manufacturing of Anode for Lithium Secondary Battery

The anode active material, binder (carboxymethyl cellulose (CMC) and styrene-butadiene rubber (SBR)) and conductive material (amorphous carbon) manufactured as described above were mixed with a solvent to manufacture an anode slurry. At this time, the contents of the anode active material, binder and conductive material were set to 94 wt %, 3 wt % and 3 wt %, respectively, based on the solid content. Thereafter, the anode slurry was applied on one surface of a copper foil (Cu-foil), which is an anode current collector, at a loading level of 10 mg/cm² to 14 mg/cm², and then dried at 90° C. to 120° C. to form an anode mixture layer on one surface of the anode current collector.

Thereafter, as illustrated in Table 2 below, the anodes for a lithium secondary battery of the examples and comparative examples were manufactured by applying a rolling process with different electrode densities depending on the examples and comparative examples. The values (OI₂) of the orientation index (OI) measured for the anode mixture layers included in the anodes of the examples and comparative examples are illustrated in Table 2 below. In detail, XRD analysis was performed on the surface of the anode mixture layer, and the orientation index (OI) values were measured in the same manner as described above.

### 3) Manufacturing of Lithium Secondary Battery

A cathode slurry containing Li [Ni_{0.8}Co_{0.1}Mn_{0.1}]O₂, a lithium transition metal composite oxide, was applied and dried on aluminum foil (Al-foil), which is a cathode current collector, to manufacture a cathode for a lithium secondary battery. Then, the secondary battery cell manufactured by interposing a polyolefin separator between the cathode and the anode was placed in a pouch for a secondary battery. Then, an electrolyte solution in which 1M of LiPF₆ was dissolved in a solvent mixed with ethylene carbonate (EC) and diethyl carbonate (DEC) was injected into the pouch for a secondary battery, and then the pouch was sealed to manufacture a pouch-type lithium secondary battery. The manufactured pouch-type lithium secondary battery was applied as a secondary battery sample of the examples and comparative examples.

### 4) Performance Evaluation

### (1) Capacity Retention Rate

The secondary battery sample was charged at a rate of 1C for 17 minutes in the range of SOC 2-96%, and the discharge cycle of 1C was repeated 300 times at 25° C. Then, the discharge capacity retention rate was measured as a % compared to the initial discharge capacity, and the results are illustrated in Table 2 below.

### 2 Electrode Expansion Rate

First, the electrode thickness (T₁) of the anode before charging (SOC 0%) was measured for the anodes of the examples and comparative examples. In addition, the secondary battery samples respectively including the anodes of the examples and comparative examples were charged (CC-CV; 1.0C, 4.2V, 0.1C CUT-OFF), and then, the electrode thickness (T₂) of the anodes after charging (SOC 100%) was measured by dissembling the secondary batteries. Thereafter, the electrode expansion rates of the charged anodes were calculated according to Formula 2 below, and the results are illustrated in Table 2 below.

$$Electrode Expansion Ratio ( \% ) = 100 \times ( {T}_{2} - {T}_{1} ) / ( {T}_{1} ) \qquad [ Formula 2 ]$$

In the above Formula 2, T₁ is the electrode thickness at SOC 0%, and T₂ is the electrode thickness at SOC 100%.

TABLE 1

| | | Average | | |
|---|---|---|---|---|
| Carbon-based | | Particle | | |
| Active | | Size (D50) | Orientation | Particle |
| Material | Type | (μm) | Index(OI) | Shape |
| Artificial | A | 10.5 | 2.42 | Single Particle |
| Graphite | B | 10.6 | 3.20 | Carbon-coated |
| | | | | Single Particle |
| | C | 11.5 | 2.89 | Carbon-coated |
| | | | | Single Particle |
| | D | 8.5 | 2.47 | Carbon-coated |
| | | | | Single Particle |
| | E | 10.6 | 3.11 | Single Particle |
| | A′ | 10.7 | 2.03 | Carbon-coated |
| | | | | A(1.0 wt %) |
| | A″ | 10.7 | 1.93 | Carbon-coated |
| | | | | A (1.5 wt %) |
| Natural | G | 11.6 | 2.33 | Spherical + |
| Graphite | | | | Carbon |
| | | | | Coating (5 wt %) |

TABLE 2

| | | | | | | | | Compar- | Compar- | Compar- | Compar- | Compar- |
|---|---|---|---|---|---|---|---|---|---|---|---|---|
| | | Exam- | Exam- | Exam- | Exam- | Exam- | Exam- | ative | ative | ative | ative | ative |
| | | ple 1 | ple 2 | ple 3 | ple 4 | ple 5 | ple 6 | Example 1 | Example 2 | Example 3 | Example 4 | Example 5 |
| Carbon- | Artificial | A | B | A′ | A′ | A | A | A″ | C | D | D | E |
| based | Graphite | | | | | | | | | | | |
| Active | Natural | — | — | — | G | G | G | — | — | — | G | G |
| material | Graphite | | | | | | | | | | | |
| | Artificial | 100:0 | 100:0 | 100:0 | 30:70 | 70:30 | 70:30 | 100:0 | 100:0 | 100:0 | 30:70 | 70:30 |
| | graphite:Natural | | | | | | | | | | | |
| | graphite | | | | | | | | | | | |
| | Weight | | | | | | | | | | | |
| | Ratio | | | | | | | | | | | |

| | | | | | | | | | | | |
|---|---|---|---|---|---|---|---|---|---|---|---|
| Electrode | 1.68 | 1.68 | 1.68 | 1.68 | 1.68 | 1.5 | 1.68 | 1.68 | 1.68 | 1.68 | 1.68 |
| Density | | | | | | | | | | | |
| (g/cc) | | | | | | | | | | | |
| Orientation | 2.42 | 3.20 | 2.03 | 2.74 | 2.96 | 2.96 | 1.93 | 2.89 | 2.47 | 2.99 | 3.11 |
| index(OI₁) | | | | | | | | | | | |
| of Carbon- | | | | | | | | | | | |
| based | | | | | | | | | | | |
| active | | | | | | | | | | | |
| material | | | | | | | | | | | |
| Orientation | 7.16 | 10.05 | 4.55 | 10.9 | 10.74 | 9.24 | 3.49 | 5.35 | 25.05 | 6.19 | 28.8 |
| index(OI₂) | | | | | | | | | | | |
| of Anode | | | | | | | | | | | |
| mixture | | | | | | | | | | | |
| layer | | | | | | | | | | | |
| Orientation | 196 | 214 | 124 | 298 | 263 | 212 | 81 | 85 | 914 | 107 | 826 |
| Index | | | | | | | | | | | |
| Increase | | | | | | | | | | | |
| Ratio(%) | | | | | | | | | | | |
| (R_{OI}) | | | | | | | | | | | |
| Capacity | 93 | 88 | 85 | 78 | 92 | 87 | 65 | 62 | 60 | 68 | 61 |
| Retention | | | | | | | | | | | |
| Rate (%) | | | | | | | | | | | |
| (1 C/1 C; | | | | | | | | | | | |
| 300 cyc) | | | | | | | | | | | |
| Electrode | 22.1 | 22.1 | 21 | 23 | 20.1 | 19.5 | 24.8 | 25.2 | 20.8 | 22 | 21.4 |
| Expansion | | | | | | | | | | | |
| Rate (%) | | | | | | | | | | | |

Referring to Tables 1 and 2 above, it can be confirmed that the capacity retention rate of the lithium secondary battery is relatively low when the orientation index (OI) increase rate (R_{OI}) is less than 1200 (Comparative Examples 1, 2, and 4) or exceeds 400% (Comparative Examples 3 and 5). In detail, in the case of Comparative Examples 1 and 2 where the orientation index (OI) increase rate (R_{OI}) is 100% or less, the electrode expansion rate is also relatively high.

It is determined that this is because the ‘spring back’ phenomenon occurred significantly in the anode after rolling in the case of Comparative Examples 1 and 2, which decreased the orientation index increase ratio. On the other hand, in the case of Comparative Examples 3 and 5, the carbon-based active material included in the anode was damaged by extreme stress during the rolling process, which caused the orientation index increase ratio of the anode to become excessively large, which deteriorated the performance of the lithium secondary battery.

Meanwhile, when the orientation index (OI) increase ratio (R_{OI}) is 120% to 400% (Examples 1 to 6), it can be confirmed that the capacity retention ratio of the lithium secondary battery is maintained relatively high. In detail, when the orientation index increase ratio (R_{OI}) is 190% to 270% (Examples 1, 2, 5, and 6), it can be confirmed that a low level of electrode expansion ratio is secured and the capacity retention ratio of the lithium secondary battery is maintained significantly high.

Considering these results, it is determined that when an anode for a lithium secondary battery is manufactured so that the orientation index increase ratio (R_{OI}) according to Formula 1 above is 120% to 400%, a lithium secondary battery with excellent performance may be provided.

As set forth above, according to an embodiment, an anode for a lithium secondary battery having excellent energy density may be provided.

According to an embodiment, a spring back phenomenon may be suppressed in an anode for a lithium secondary battery.

According to an embodiment, an anode for a lithium secondary battery having excellent lifespan characteristics may be provided.

According to an embodiment, economic feasibility may be secured when manufacturing an anode for a lithium secondary battery.

Only specific examples of implementations of certain embodiments are described. Variations, improvements and enhancements of the disclosed embodiments and other embodiments may be made based on the disclosure of this patent document.

### DESCRIPTION OF REFERENCE NUMERALS

1: Carbon-based active material
2: Basal plane
3: Edge plane

What is claimed is:

1. An anode for a lithium secondary battery, comprising:
an anode current collector and an anode mixture layer on at least one surface of the anode current collector,
wherein the anode mixture layer includes a carbon-based active material, and
the anode for a lithium secondary battery has an orientation index increase ratio (R_{OI}) of 120% to 400% according to Formula 1,
$${R}_{O I} = 100 \times ( O {I}_{2} - O {I}_{1} ) / ( {OI}_{1} ) , \qquad [ Formula 1 ]$$
where R_{OI} is an orientation index (OI) increase rate (%), OI₁ is a ratio (I₀₀₄/I₁₁₀) of a peak intensity (I₀₀₄) of the (004) plane to a peak intensity (I₁₁₀) of the (110) plane according to X-ray diffraction (XRD) analysis of the carbon-based active material, and OI₂ is a ratio (I₀₀₄/I₁₁₀) of a peak intensity (I₀₀₄) of the (004) plane to a peak intensity (Iro) of the (110) plane according to X-ray diffraction (XRD) analysis of the anode mixture layer.

2. The anode for a lithium secondary battery of claim 1, wherein the anode for a lithium secondary battery has an orientation index increase ratio (R_{OI}) of 190% to 270%.

3. The anode for a lithium secondary battery of claim 1, wherein the anode for a lithium secondary battery has an OI₂ value of 7 to 15.

4. The anode for a lithium secondary battery of claim 1, wherein the carbon-based active material includes artificial graphite.

5. The anode for a lithium secondary battery of claim 4, wherein the artificial graphite has a single particle form.

6. The anode for a lithium secondary battery of claim 4, wherein the artificial graphite includes a carbon coating layer on a surface thereof.

7. The anode for a lithium secondary battery of claim 1, wherein the carbon-based active material includes artificial graphite and natural graphite.

8. The anode for a lithium secondary battery of claim 7, wherein a weight of the artificial graphite in the carbon-based active material is equal to or greater than a weight of the natural graphite.

9. The anode for a lithium secondary battery of claim 7, wherein the natural graphite includes a carbon coating layer on a surface thereof.

10. The anode for a lithium secondary battery of claim 1, wherein an electrode density of the anode mixture layer is 1.4 g/cc to 1.7 g/cc.

11. A lithium secondary battery comprising the anode for a lithium secondary battery according to claim 1.
